(19) United States
(12) Patent Application Publication
(10) Pub. No.: US 2023/0001606 A1
(43) Pub. Date: Jan. 5, 2023

(54) METHOD AND APPARATUS FOR MANUFACTURING AN OBJECT

(71) Applicant: University of Canterbury, Christchurch (NZ)

(72) Inventors: Donald Murray CLUCAS, Christchurch (NZ); Hossein NAJAF ZADEH, Christchurch (NZ); Tim HUBER, Christchurch (NZ)

(21) Appl. No.: 17/781,155

(22) PCT Filed: Dec. 3, 2020
(86) PCT No.: PCT/NZ2020/050165

§ 371 Date: May 31, 2022

(30) Foreign Application Priority Data
Dec. 4, 2019 (NZ) 759844

(51) Int. Cl. B29C 33/38; B29C 64/214; B29C 64/264; B29C 64/321; B29C 64/35; B29C 64/245; B29C 64/165; B33Y 10/00; B33Y 30/00; B33Y 70/00; B33Y 80/00

(52) U.S. Cl. CPC B29C 33/3842; B29C 64/214; B29C 64/264; B29C 64/321; B29C 64/35; B29C 64/245; B29C 64/165; B33Y 10/00; B33Y 30/00; B33Y 70/00; B33Y 80/00; B29K 2091/00

(57) ABSTRACT

An apparatus for the manufacture of an object, the apparatus having a print bed, a stencil, a heater arranged to heat the stencil, and a squeegee. The stencil comprises one or more apertures and is positionable over the print bed. The squeegee is movable to spread a printing material across the stencil and to thereby force printing material through the stencil aperture(s). One or both of the stencil and the print bed is movable to adjust the spacing between the stencil and the print bed.

### FIELD OF THE INVENTION

This invention relates to a method and apparatus for manufacturing an object. In particular the invention relates to a three-dimensional printer for layer-wise manufacture of an object such as a mould. The invention also particularly relates to a method for manufacture of an object such as a hydrogel using a mould such as a wax mould.

### BACKGROUND

Additive manufacturing methods, commonly referred to as three-dimensional printing methods, offer a number of benefits over traditional manufacturing methods. These methods enable the fabrication of complex parts, and/or one-off parts, often at low-cost. They are also commonly used for rapid fabrication of objects for prototyping purposes. However, the suitability and accuracy of objects produced by additive manufacturing is material and method dependent. Generally, methods capable of producing objects with high resolution features are time consuming.

In particular, additive manufacturing methods for creating three dimensional structures from soft materials and/or biocompatible materials such as hydrogels have a number of challenges. Inkjet-type printing is generally not suitable for printing hydrogel parts. Further, inkjet-type printing of high-resolution parts requires a high resolution print head. Print heads with small orifices can be susceptible to blockages and result in increased print time. Other additive manufacturing methods may be limited in the types of structures they are suitable for, may result in cell damage to the hydrogel during manufacture, or are slow and not suitable for mass production. Therefore, there is currently a lack of suitable high-speed mass manufacturing methods for producing three dimensional hydrogel structures with high resolution features.

Further, existing additive manufacturing methods often result in waste material as a by-product of the manufacturing process, particularly where a support material has been used during the manufacturing process. The amount of waste product can be significant, particularly in mass manufacture situations. Removal of the supports can also be very time consuming and expensive. For cost and sustainability reasons, it is desirable to reduce waste produced by the manufacturing process.

It is an object of at least preferred embodiments of the present invention to address one or more of the above mentioned disadvantages and/or to at least provide the public with a useful alternative.

In this specification where reference has been made to patent specifications, other external documents, or other sources of information, this is generally to provide a context for discussing features of the invention. Unless specifically stated otherwise, reference to such external documents or sources of information is not to be construed as an admission that such documents or such sources of information, in any jurisdiction, are prior art or form part of the common general knowledge in the art.

### SUMMARY OF THE INVENTION

In a first aspect the invention broadly consists in an apparatus for the manufacture of an object, comprising: a print bed, a stencil, a heater arranged to heat the stencil; and a squeegee. The stencil comprises one or more apertures and is positionable over the print bed. The squeegee is movable to spread a printing material across the stencil and to thereby force printing material through the stencil aperture(s). One or both of the stencil and the print bed is movable to adjust the spacing between the stencil and the print bed.

The print bed may be vertically movable to raise and lower the print bed relative to the stencil.

The heater may comprise a radiant heater. For example, in an embodiment, the heater comprises one or more infrared lamps. The lamps may be elongate lamps positioned adjacent sides of the stencil.

The stencil may comprise a frame and a stencil plate that is pre-tensioned by the frame, the stencil aperture(s) being provided in the stencil plate. The frame may comprise first and second end supports attached to the plate, and elongate first and second side members extending between the end supports.

The side members may apply a pre-tension to the stencil plate via the end supports. In an embodiment, the side members comprise threaded rods, each rod being provided with one or more nuts that is adjustable to adjust the pre-tension applied to the stencil plate.

Each side member may comprise a biasing member acting between said side member and an end support to apply the pre-tension.

In an embodiment, the heater is configured to heat the stencil to a predetermined temperature. The predetermined temperature is preferably sufficient to melt the printing material when the printing material is in contact with the stencil, or to keep the material molten. For embodiments where the printing material is in viscous/liquid form, the predetermined temperature is preferably sufficient to reduce the viscosity of the printing material to enable the squeegee to spread the material and force the material through the stencil apertures.

Preferably when the stencil is at the pre-determined temperature the tension in the stencil plate is sufficient to prevent deflection of the plate beyond an allowable deflection limit upon a downward force applied by the squeegee.

In an embodiment, the stencil plate comprises stainless steel. The stencil frame may comprise a handle, the frame and/or the handle may also comprise stainless steel. Alternatively, the stencil plate and/or the frame may comprise other suitable materials such as steel or another metal. The plate may comprise a metal or fabric mesh.

In an embodiment, the predetermined temperature is a temperature of between about 81° C. and about 87° C., for example between about 83° C. and about 85° C., more preferably about 84° C. This may be suitable for embodiments wherein the printing material is wax.

The stencil may comprise two or more locating notches or locating protrusions for locating the stencil relative to the print bed. In an embodiment, the stencil comprises two locating notches. The notches may comprise one or more curved and or one or more straight edges. In an embodiment the edge of the notch is substantially arcuate. In an alternative embodiment, the notches may be substantially v-shaped.

The apparatus may further comprise a print table, the print beds being mounted to the print table. The print table may comprise two or more locating notches or locating protrusions complementing the locating notches or locating protrusions of the stencil, to locate the stencil relative to the print bed.

The stencil is preferably linearly movable into and out of engagement with the locating notches or protrusions on the print table.

The squeegee may comprise an angled blade, wherein a leading surface of the blade forms an acute angle with a top surface of the stencil.

In an embodiment, the squeegee comprises a pair of oppositely angled blades. The pair of blades may comprise facing leading surfaces, with each leading surface an acute angle with a top surface of the stencil. Preferably the two blades are both oppositely orientated at substantially the same angle. Each squeegee blade may be independently movable towards and away from the top surface of the stencil. Alternatively, the squeegee may comprise a single adjustable angled blade that may be adjustable to facilitate moving the squeegee across the stencil plate in opposite directions.

The, or each, squeegee blade is vertically movable relative to the stencil plate. The, or each blade is preferably configured to apply a substantially even pressure to the stencil plate along the length of the blade when the squeegee blade is in contact

In an embodiment, the blade(s) comprise(s) polytetrafluoroethylene (PTFE/Teflon). Alternatively the squeegee blade may comprise any other suitable material such as stainless steel. Preferably the squeegee blade material has low thermal expansion and/or has a low coefficient of friction with the stencil plate material, and/or is temperature resistant at the pre-determined temperature for the stencil. In an embodiment, the squeegee blade(s) is/are temperature resistant to at least 200° C.

The apparatus may further comprise a secondary material applicator configured to apply a second printing material to objects formed or partly formed by the first printing material. The second printing material may comprise a liquid material such as a cellulose solution, alternatively the second printing material may comprise a powdered solid material such as a metal powder or polymer.

In some embodiment, the print bed may be configured to selectively vibrate. For example, during or after application of the second printing material.

The apparatus may optionally further comprise a tertiary applicator, for example, for applying a binder for binding metal powders to form a green body.

The secondary and/or tertiary applicator may comprise an ink jet head, a spray gun, or a further stencil, for example.

The apparatus may include a cleaner configured to remove printing material from an underside of the stencil. The cleaner may comprise a roller or a wiper. In some embodiments, the cleaner comprises an absorbent material such as tissue or washable cloth.

In some embodiments, the cleaner comprises a cleaning ribbon extending from a first spool, over a cleaning head, and to the second spool. The cleaning head is able to be positioned to be in contact with a surface of a stencil to assist with cleaning the surface. The first and/or second spool are provided with motors to pull clean ribbon across the surface of the stencil. The cleaning head may be movable back and forward to wipe the clean ribbon along the surface of the stencil.

In a second aspect the invention broadly consists in a system for the manufacture of an object. The system comprises a print station and a print bed that is laterally movable relative to the print station. The print station comprises a stencil having one or more apertures, a heater arranged to heat the stencil, and a squeegee movable to spread a printing material across the stencil and thereby force printing material through the stencil aperture(s).

One or both of the stencil and the print bed may be movable to adjust a vertical spacing between the stencil and the print bed.

The system may comprise a movable print table. The print table may comprise a plurality of print beds. Alternatively the system may comprise a plurality of print tables, each table comprising at least one print bed. In an embodiment, the print table is rotatable to laterally move the print beds relative to the print stations. Alternatively the, or each, print table may be movable rectilinearly.

The stencil may comprise two or more locating notches or locating protrusions. The, or each, print table may comprise two or more locating notches or locating protrusions complementing the locating notches or locating protrusions of the stencil, at each print bed, for locating the stencil relative to the respective print bed.

The stencil is preferably linearly movable into and out of engagement with the locating notches or protrusions on the print table.

The notches may comprise a curved and or one or more straight edges. In an embodiment the edge of the notch is substantially arcuate. In an alternative embodiment, the notches may be substantially v-shaped.

The heater may comprise a radiant heater. For example, in an embodiment, the heater comprises one or more infrared lamps. The lamps may be elongate lamps positioned adjacent sides of the stencil.

The stencil may comprise a frame and a stencil plate that is pre-tensioned by the frame, the stencil aperture(s) being provided in the stencil plate. The frame may comprise first and second end supports attached to the plate, and elongate first and second side members extending between the end supports.

The stencil and stencil frame may have any one or more of the features described above in relation to the first aspect, for example the side members may comprise threaded rods and/or each side member comprises a biasing member acting between said side member and an end support to apply the pre-tension.

In an embodiment, the heater is configured to heat the stencil to a predetermined temperature. The predetermined temperature is preferably sufficient to melt the printing material when the printing material is in contact with the stencil, to keep the material molten. For embodiments where the printing material is in viscous/liquid form, the predetermined temperature is preferably sufficient to reduce the viscosity of the printing material to enable the squeegee to spread the material and force the material through the stencil apertures.

In an embodiment, the stencil plate comprises stainless steel. The stencil frame may comprise a handle, the frame and/or the handle may also comprise stainless steel. Alternatively, the stencil plate and/or the frame may comprise other suitable materials such as an alternative steel alloy or another metal. The stencil plate may comprise a metal or fabric mesh.

In an embodiment, the predetermined temperature is a temperature of between about 81° C. and about 87° C., for example between about 83° C. and about 85° C., more preferably about 84° C. This may be suitable for embodiments wherein the printing material is wax.

The squeegee may comprise an angled blade, wherein a leading surface of the blade forms an acute angle with a top surface of the stencil.

In an embodiment, the squeegee comprises a pair of oppositely angled blades. The pair of blades may comprise facing leading surfaces, with each leading surface an acute angle with a top surface of the stencil. Preferably the two blades are both oppositely orientated at substantially the same angle. Each squeegee blade may be independently movable towards and away from the top surface of the stencil. Alternatively, the squeegee may comprise a single adjustable angled blade that may be adjustable to facilitate moving the squeegee across the stencil plate in opposite directions.

The, or each, squeegee blade is vertically movable relative to the stencil plate. The, or each blade is preferably configured to apply a substantially even pressure to the stencil plate along the length of the blade when the squeegee blade is in contact

In an embodiment, the blade(s) comprise(s) polytetrafluoroethylene (PTFE/Teflon). Alternatively, the squeegee blade may comprise any other suitable material such as stainless steel. Preferably the squeegee blade material has low thermal expansion and/or has a low coefficient of friction with the stencil plate material, and/or is temperature resistant at the pre-determined temperature for the stencil. In an embodiment, the squeegee blade(s) is/are temperature resistant to at least 200° C.

The system may further comprise one or more of: a secondary material application station, a curing or heating station, a vacuum application station, a shaving station to plane a top surface of the object, and an object removal station. One embodiment comprises a secondary material application station having a secondary material applicator configured to apply a second printing material to objects formed or partly formed by the first printing material. The second printing material may comprise a liquid material such as a cellulose solution, alternatively the second printing material may comprise a powdered solid material such as a metal powder.

In some embodiment, the print bed may be configured to selectively vibrate. For example, during or after application of the second printing material.

The system may optionally further comprise a tertiary material application station, for example, for applying a tertiary material such as a binder for binding metal powders to form a green body.

The secondary and/or tertiary application station may comprise an ink jet head, or a spray gun, for example.

The system may include a cleaner configured to remove printing material from an underside of the stencil. The cleaner may comprise a roller or a wiper. In some embodiments, the cleaner comprises an absorbent material such as tissue or cloth. The cleaner may be provided as part of the printing station.

The system may comprise a plurality of printing stations. Each print station may comprise a single stencil, or may comprise a plurality of interchangeable stencils.

In a third aspect the invention broadly consists in method of manufacturing an object. The method comprises the steps of: providing a print bed; providing a stencil having one or more apertures, and positioning the stencil over the print bed; heating the stencil; applying a printing material to the stencil; moving a squeegee across the stencil to force molten printing material through the stencil aperture(s) to form a layer of the object or a layer of a mould; and moving one or both of the stencil and the print bed to adjust a vertical spacing between the stencil and the print bed.

In an embodiment, the stencil comprises two or more locating notches or locating protrusions, and wherein the step of positioning the stencil over the print bed comprises engaging the notches or protrusions with complementary notches or protrusions on or adjacent the print bed.

The notches may comprise a curved and or one or more straight edges. In an embodiment the edge of the notch is substantially arcuate. In an alternative embodiment, the notches may be substantially v-shaped.

The stencil may comprise a stencil plate and a frame, and the method may comprise the step of applying a tensile force to the stencil plate via the frame. The stencil frame may have any one or more of the features described above in relation to the stencil frame of the first or second aspects.

In an embodiment, the step of heating the stencil comprises heating the stencil to a predetermined temperature sufficient to melt the printing material when the printing material is in contact with the stencil, or to keep the material molten. For embodiments where the printing material is in viscous/liquid form, the step of heating the stencil comprises heating the stencil to a temperature sufficient reduce the viscosity of the printing material to enable the squeegee to spread the material and force the material through the stencil apertures.

In an embodiment, the printing material comprises wax, and the predetermined temperature is a temperature of between about 81° C. and 87° C. For example, between about 83° C. and about 85° C., more preferably about 84° C. This may be suitable for embodiments wherein the printing material is wax.

The heater may comprise a radiant heater. For example, in an embodiment, the heater comprises one or more infrared lamps. The lamps may be elongate lamps positioned adjacent sides of the stencil.

The step of moving one or both of the stencil and the print bed to adjust a vertical spacing between the stencil and the print bed may comprise, after moving the squeegee across the stencil to force molten printing material through the stencil aperture(s) and while the squeegee is in contact with a top surface of the stencil, moving the print bed away from the stencil to increase a vertical spacing between the stencil and the print bed.

The method may further comprise the step of removing the stencil from over the print bed, and placing a second stencil over the print bed, and after placing the second stencil over the print bed, moving the print bed towards the stencil to decrease a vertical spacing between the stencil and the print bed.

The method may comprise the step of moving the print bed laterally any one of: a secondary print station, a secondary material application station, a curing or heating station, a vacuum application station, and/or an object removal station.

The, or each, print bed may be provided on a print table. The method may comprise moving the table to move the print beds transversely relative to the print station. In one embodiment a plurality of print beds are provided on a rotatable print table, and the method comprises rotating the print table to laterally move the print beds relative to the print stations.

The method may comprise the step of applying a second printing material to a mould or an object formed or partly formed by the first printing material. The second printing material may comprise a liquid material such as a cellulose solution, alternatively the second printing material may comprise a powdered solid material such as a metal powder.

The method may comprise the step of vibrating the print bed, for example, during or after application of the second printing material.

The method may further comprise applying a tertiary material to the first or second materials, for example by applying a binder to binding metal powders to form a green body.

The method may include a cleaning step comprising removing printing material from an underside of the stencil. A roller or a wiper may be used as a cleaner to remove the printing materials. In some embodiments, the cleaner comprises an absorbent material such as tissue or cloth.

The squeegee may comprise an angled blade, wherein a leading surface of the blade forms an acute angle with a top surface of the stencil. The squeegee may have any one or more of the features described above in relation to the first or second aspects.

In an embodiment, the squeegee comprises a pair of oppositely angled blades and the method comprises moving first blade in first direction to print a first layer of print material, then raising the first blade and lowering the second blade and moving the second blade in a second direction to print a second layer of print material. The first layer may be printed on a first print bed (or on an object partly formed on the first print bed). The second layer may be printed on a second print bed (or on an object partly formed on the second print bed)

In an alternative embodiment, the squeegee may comprise a single adjustable angled blade that may be adjustable between first and second positions to facilitate moving the squeegee across the stencil plate in opposite directions, and the method may comprise placing the blade in a first position and moving the blade in first direction to print a first layer of print material, then placing the blade in the second position and moving the blade in a second direction to print a second layer of print material.

In an embodiment, the blade(s) comprise(s) polytetrafluoroethylene (PTFE/Teflon). Alternatively the squeegee blade may comprise any other suitable material such as stainless steel. Preferably the squeegee blade material has low thermal expansion and/or has a low coefficient of friction with the stencil plate material, and/or is temperature resistant at the pre-determined temperature for the stencil. In an embodiment, the squeegee blade(s) is/are temperature resistant to at least 200° C.

In an embodiment, the method comprises printing a mould, and further includes the steps of submersing the mould in a liquid or injecting the mould with a liquid, and curing or setting the liquid. The liquid is preferably a gel-able liquid such as a cellulose solution. The method may comprise applying a vacuum to the liquid containing mould before curing or setting the liquid.

The step of curing or setting the liquid may comprise heating the liquid to cause it to gel.

The method may further include the step of heating the mould to melt the mould material. For example, this step may comprise submerging the mould in hot water. In some embodiments the water is at least 80° C.

For embodiments where the secondary material comprises a metal powder, the metal powder is bound, for example, with a binder, then the resulting green body is sintered. The step of sintering may cause the supporting mould to melt.

In a fourth aspect, the invention broadly consists in object manufactured according to the method described above in relation to embodiments of the third aspect, wherein the object is a mould.

The mould may comprise a wax mould.

The mould may comprise a biocompatible material.

In a fifth aspect, the invention broadly consists in object manufactured according to the method described above in relation to embodiments of the third aspect, wherein the object is a gel object.

The object may comprise a gel column.

The object may comprise an array of gyroid structures.

In a sixth aspect, the invention broadly consists in object manufactured according to the method described above in relation to embodiments of the third aspect, wherein the object comprises a metal or polymer.

In a seventh aspect, the invention broadly consists in a method for manufacturing a gel object comprising the steps of: forming a wax mould through a layer-wise manufacturing process, the mould having at least one cavity; filling the mould cavity or cavities with liquid; curing or setting the liquid; and melting the mould to leave a gel object.

The liquid is preferably a gel-able liquid such as a cellulose solution. The method may comprise applying a vacuum to the liquid containing mould before curing or setting the liquid.

The step of curing or setting the liquid may comprise heating the liquid to cause it to gel.

The step of melting the mould may comprise submerging the mould in hot water. In some embodiments the water is at least 80° C. The water may comprise a surfactant to facilitate separation of the wax from the gel object.

The step of forming a wax mould may comprise the method described above in relation to the third aspect. Alternatively the wax mould may be manufactured using other additive manufacturing methods such as ink-jet type printing.

The object may comprise a gel column.

The object may comprise an array of gyroid structures.

The method may further comprise the step of recycling/reusing the melted wax from the wax mould.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting. Where specific integers are mentioned herein which have known equivalents in the art to which this invention relates, such known equivalents are deemed to be incorporated herein as if individually set forth.

The term ‘comprising’ as used in this specification and claims means ‘consisting at least in part of’. When interpreting statements in this specification and claims that include the term ‘comprising’, other features besides those prefaced by this term can also be present. Related terms such as ‘comprise’ and ‘comprised’ are to be interpreted in a similar manner.

It is intended that reference to a range of numbers disclosed herein (for example, 1 to 10) also incorporates reference to all rational numbers within that range and any range of rational numbers within that range (for example, 1 to 6, 1.5 to 5.5 and 3.1 to 10).

Therefore, all sub-ranges of all ranges expressly disclosed herein are hereby expressly disclosed.

As used herein the term ‘(s)’ following a noun means the plural and/or singular form of that noun. As used herein the term ‘and/or’ means ‘and’ or ‘or’, or where the context allows, both.

### BRIEF DESCRIPTION OF THE DRAWINGS

The present invention will now be described by way of example only and with reference to the accompanying drawings in which:

FIG. 1 is a flow schematic illustrating one embodiment method for manufacturing a wax mould and hydrogel structure;

FIG. 2 is a side view of a three dimensional printing unit according to one embodiment of the invention, having a rotating printing table, a printing station, and a stencil store;

FIG. 3 is a side view of the printing station of the printing unit of FIG. 2;

FIG. 4A is a perspective view of the printing station of FIG. 2;

FIG. 4B is a perspective view corresponding to FIG. 4B but additionally showing the heater;

FIG. 5 is a perspective view of the rotating print table and support frame of the printing station of FIGS. 1 to 4B;

FIG. 6 is a partial plan view showing a portion of a rotating print table of FIG. 5, with a stencil positioned at one of the print beds;

FIG. 7 is a partial perspective view corresponding to the view of FIG. 6, and showing a height adjustable print bed mounted to the table;

FIG. 8 is a perspective view of an exemplary stencil and tensioning frame for positioning on the print table of FIGS. 6 and 7;

FIG. 9 is a plan view of a further embodiment stencil, without the tensioning frame;

FIG. 10 is a perspective view of a vacuum cover applied over a wax object printed using the printing unit of FIGS. 2 to 9, for applying a vacuum to the object;

FIG. 11 is a perspective view of a single triply periodic minimal surface (TPMS) gyroid unit cell;

FIG. 12 is a perspective view of a two-dimensional array of the unit cell of FIG. 11;

FIG. 13 illustrates twenty stencil patterns for layering to create the two-dimensional array of FIG. 12;

FIG. 14 illustrates an alternative embodiment stencil loading mechanism;

FIG. 15 is a perspective view of a stencil cleaning mechanism, with the cleaning ribbon removed; and

FIG. 16 is a further view of the stencil cleaning mechanism of FIG. 15, showing the cleaning ribbon.

### DETAILED DESCRIPTION OF A PREFERRED EMBODIMENT

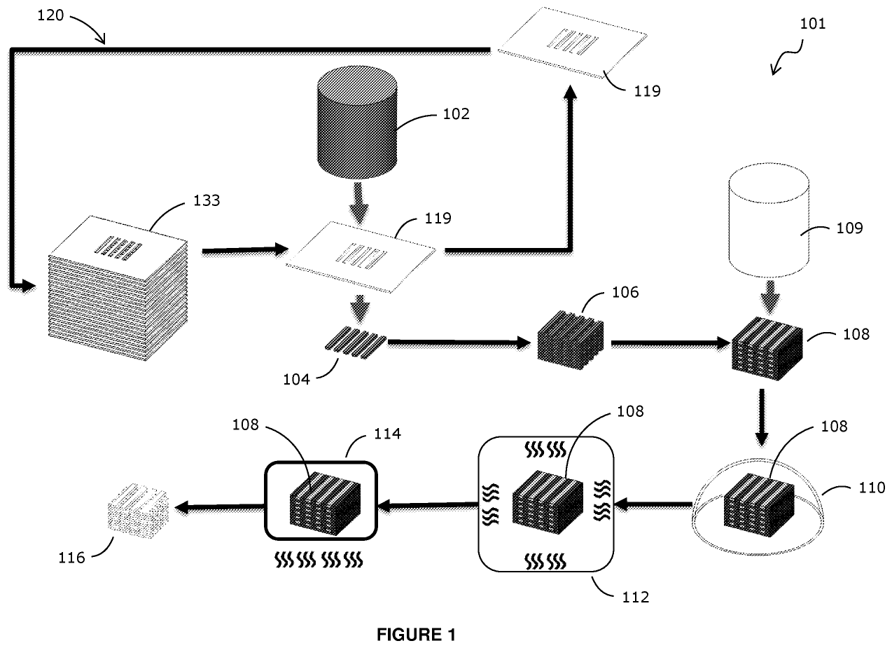

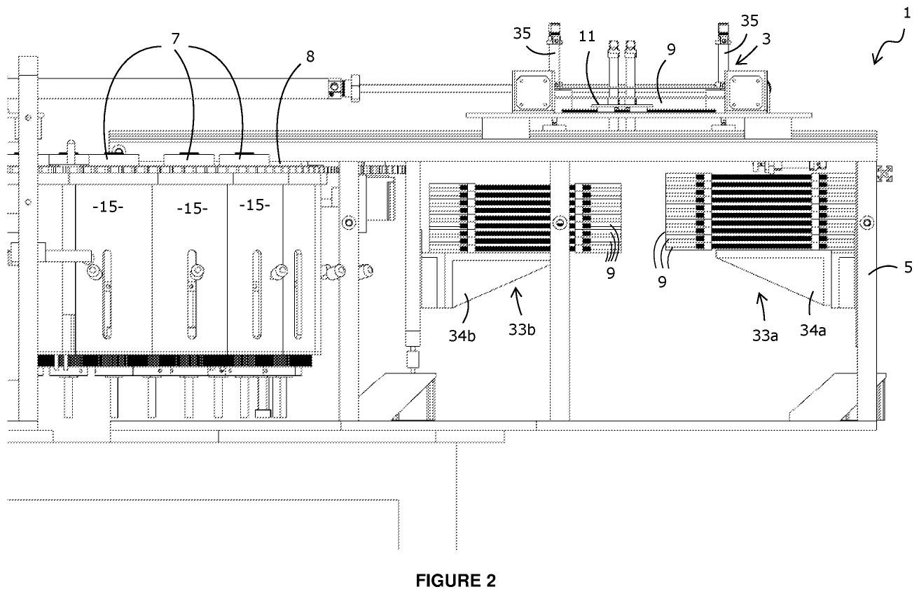

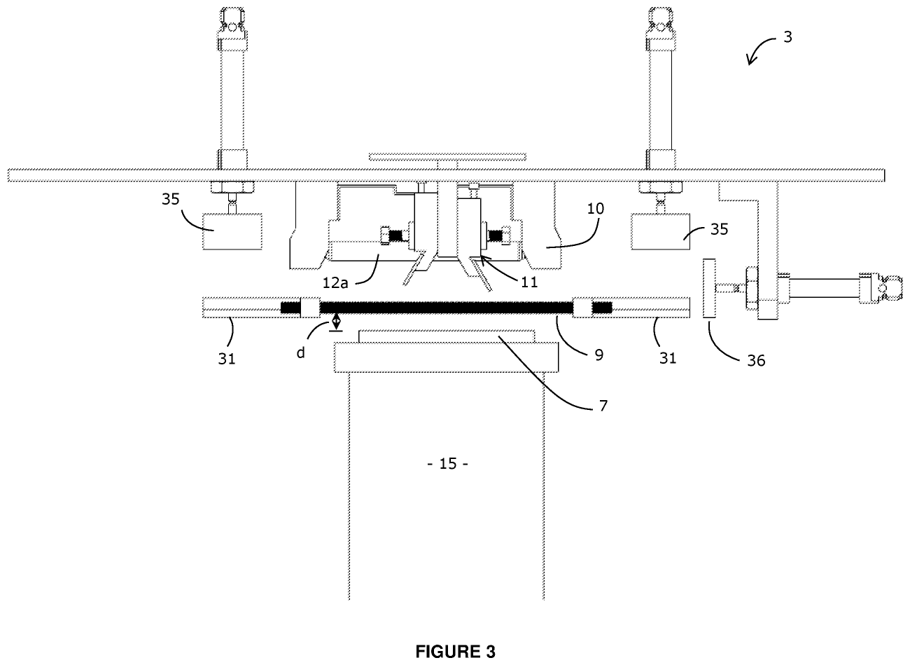

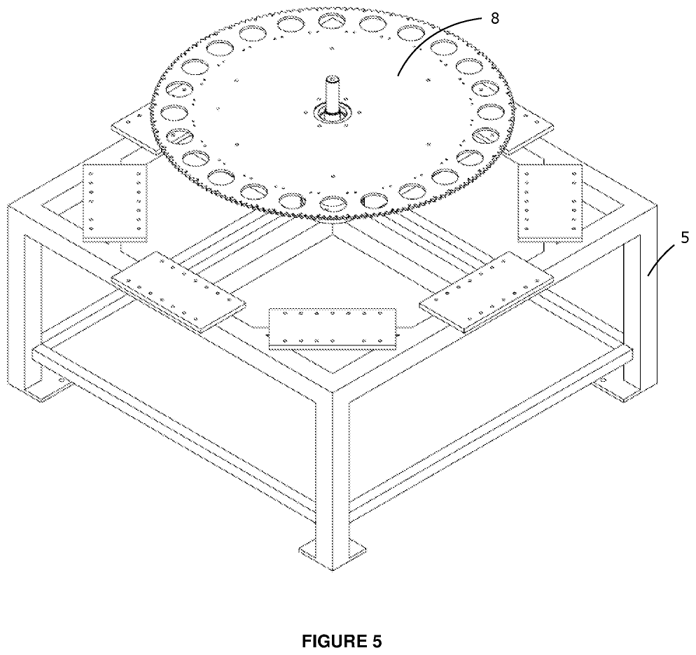

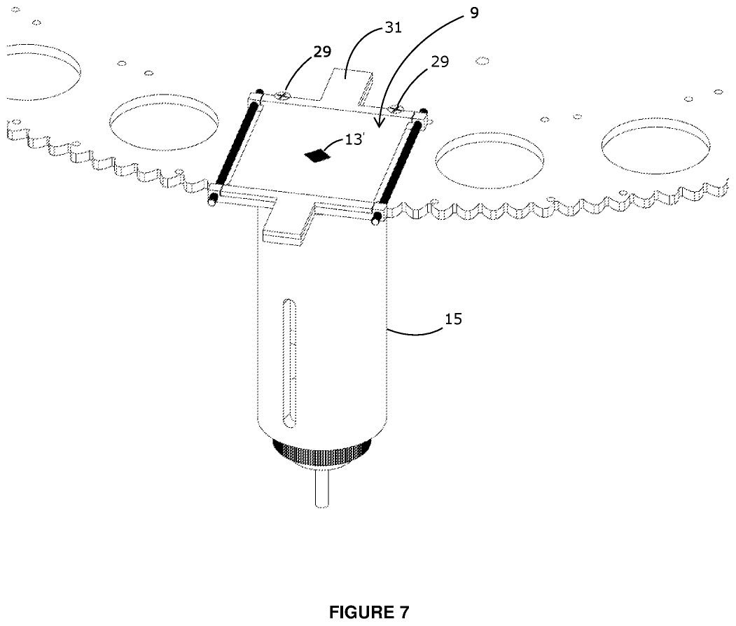

The present invention will now be described with reference to FIGS. 1 to 10 which show an exemplary embodiment apparatus and method for the manufacture of an object. The apparatus 1 shown in FIG. 2 comprises at least one print bed 7 and at least one stencil 9 having one or more apertures 13. The stencil 9 is positionable over the print bed 7. In the embodiment shown, a plurality of movable print beds 7, and a plurality of interchangeable stencils 9 are provided.

The apparatus comprises a heater 10 arranged to heat the stencil 9; and a squeegee 11 movable to spread a printing material across the stencil 9 and to thereby force printing material through aperture(s) 13 in the stencil. Passing the printing material through the stencil apertures 13 forms a layer of printing material on the print bed 7, to form the object in a layer-wise manner. One or both of the stencil 9 and the print bed 7 is movable to adjust the spacing between the stencil and the print bed, and thereby to enable the printing of successive layers.

In the embodiment shown, the heater 10, stencil 9, and squeegee 11 form a print assembly 3 that is supported on a frame 5 and horizontally movable relative to the frame and print beds 7. The print beds 7 are each supported by a respective print bed adjustment assembly 15 arranged adjacent the perimeter of a rotatable print table 8. The print bed adjustment assemblies 15 and thereby the print beds 7 are also laterally movable relative to the frame 5 and print assembly 3 by rotating the print table 8.

The print bed adjustment assemblies 15 each comprise a housing, for example a cylindrical housing, in which the print beds 7 can move up and down, and a mechanism for vertically moving the print beds 7. The mechanism may comprise a mechanical, electromechanical, or pneumatic arrangement. In the embodiment shown, each print bed 7 can be moved vertically using a screw mechanism driven by a stepper motor. That is, the print bed 7 can be raised or lowered relative to the stencil 13 and relative to the housing. The print beds 7 are movable up and down in increments, with each increment being equal to the thickness of a print layer. The stepper motor, electromagnets or other means may be configured or provided to selectively lock the print beds 7 in position at the desired height.

The print beds 7 may comprise a removable print surface to aid removal of the object after manufacture and to enable easier cleaning. The print material is deposited via the stencil 9, directly onto the top surface of the print surface. The print surface can then be removed along with the object at the end of the fabrication process. The print surface may comprise an embedded magnet or a mechanical fastener, enabling the print surface to be held to the remainder of the print beds 7, for example using an electromagnet for the duration of the printing process. At the time of object removal, the electromagnet can be deactivated to release the print surface and the fabricated object from the print bed assembly 15.

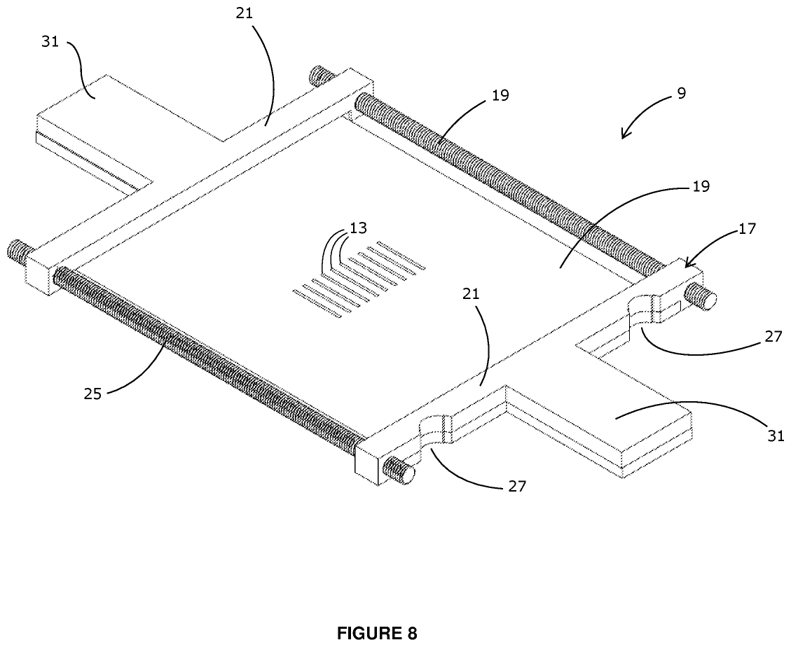

FIG. 8 illustrates an exemplary stencil 9 for use in the apparatus of FIG. 2. The stencil 9 comprises a frame 17 and a stencil plate 19 that is pre-tensioned by the frame 17. The stencil plate comprises a metal plate, for example it may comprise a solid sheet of stainless steel, an alternative steel alloy, or a metal mesh or fabric with some of the pores filled to form the stencil.

The stencil aperture(s) 13 are provided in the stencil plate and may be formed using any suitable method, such as by chemical etching, laser cutting, CNC micro milling, or hybrid fabrication. Generally, fabrication using a laser cutter can produce a stencil with higher resolution features such as smaller features, sharp corners, and straight cuts, and so is preferred where high print resolution (but not nanoscale resolution) is desired.

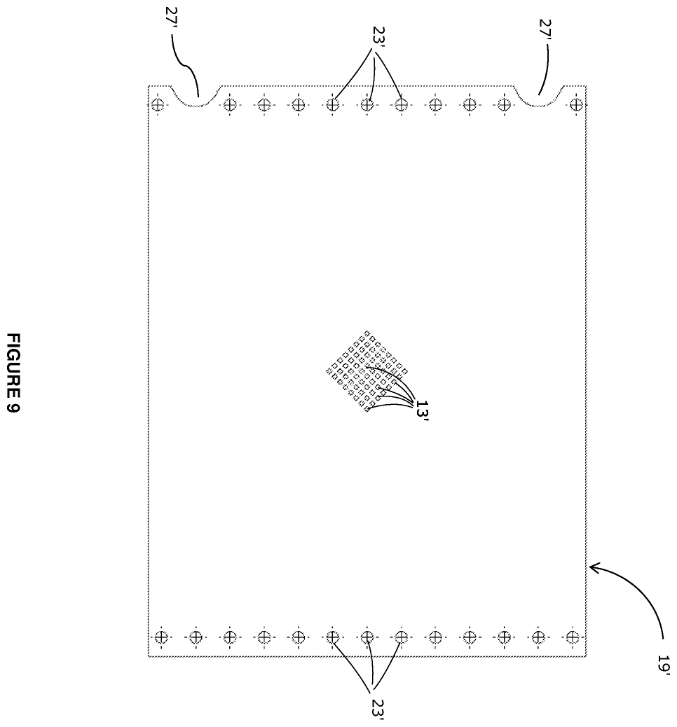

The frame 17 comprises first and second end supports 21 that attach to opposite ends of the stencil plate 19. A stencil plate 19′ for a second embodiment stencil is illustrated in FIG. 9, with the frame removed (this second embodiment stencil plate 19′ has a different arrangement of apertures 13′ but is for use with an identical frame 17). In the embodiments of FIGS. 8 and 9, each frame end support 21 is a two part member that receives and clamps to a respective end of the stencil plate 19, 19′. As illustrated in FIG. 9, the stencil plate 19 may have a row of apertures 23′ at each end of the plate, to facilitate screwing the two parts of each end support 21 together to clamp to the stencil plate 19, 19′. The apertures 23′ in the plate 19′ receive the screws that engage the two parts of the respective end member 21.

The frame 17 further comprises elongate first and second side members 25 extending between the end supports 21. The side members 25 hold the end supports 21 spaced apart and apply a pre-tension to the stencil plate 19 via the end supports 21. In the embodiment shown, the side members 25 comprise threaded rods. Two nuts (not shown) are provided on each rod, with each nut arranged to contact an inner surface of a respective end support 21, and thereby to urge the end supports 21 away from each other. This applies a tensile force to the stencil plate 19 to pre-tension the plate 19. At least one of the nuts on each threaded rod 25 is adjustable to increase or decrease the force applied to the end supports 21 and thereby to adjust the pre-tension applied to the stencil plate 19.

This pre-tension advantageously minimises deflection of the stencil plate 19 during printing. Deflection of the plate 19 is undesirable as it can cause print defects. The pre-tension is preferably selected to prevent deflection of the plate beyond an allowable amount upon a downward force applied by the squeegee, when the stencil 9 is at an operating temperature.

In alternative embodiments, a biasing member may be provided on each frame side member 25, acting between the side member (for example, against a nut provided on the side member), and the end support 21 to apply the pre-tension force to the stencil plate 19.

Each stencil frame 17 further comprises a pair of handles 31. In the embodiment shown, each handle 31 extends from and is integral with the respective end support 21. The handles 31 facilitate lifting and positioning of the stencil 9.

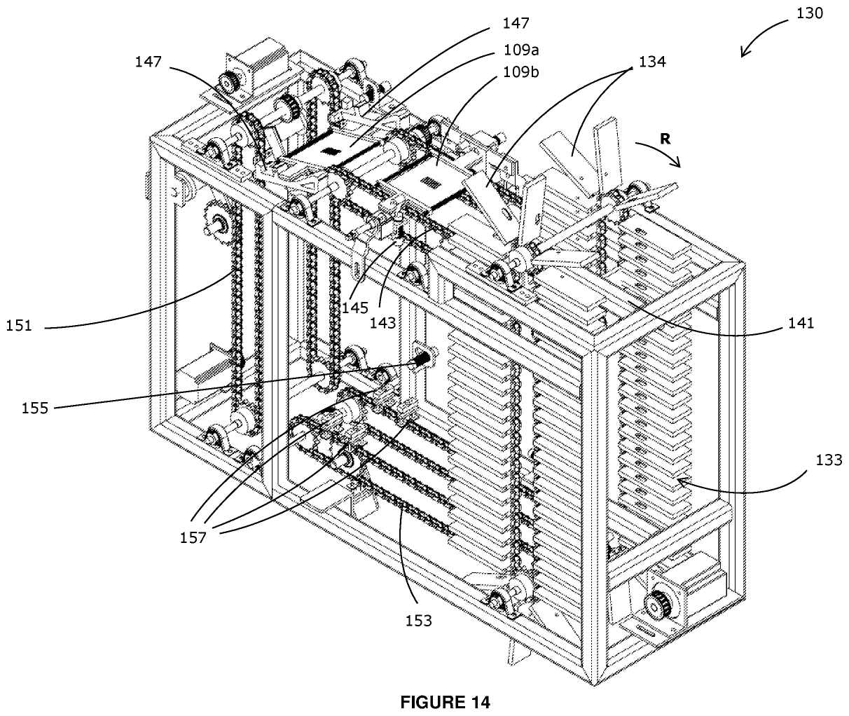

In the embodiment shown, a plurality of stencils 9 are provided, with each stencil 9 corresponding to a layer of the object. The stencils are stacked 33a in reverse build order, with the stencil corresponding to the lowest layer stacked at the top, and the stencil for the top most layer being at the bottom. The print assembly 3 comprises stencil lifters 35. The stencil lifters 35 comprise electromagnets and are operable to lift a stencil 9 from a first stack 33a by activation of the electromagnet to engage the handles 31, and to release the used stencil 9 onto a second stack 33b by deactivation of the electromagnet. An elevator 34a feeds the stencils 9 in the first stack upwards, such that the topmost stencil 9 is at a height for engagement with the stencil lifters 35. Similarly, an elevator 34b moves the stencils 9 in the second stack 33b downwards, as used stencils are collected. Stencils returned to the second stack may be moved to the bottom of the first stack for the printing of objects with repeating sets of layers. In alternative embodiments, stencils may be interchanged using a robotic arrangement and a stencil store. FIG. 14 shows an alternative stencil loading apparatus 130 for storing and receiving stencils for use on the print beds. A stack of stencils are stored in a lift carousel 133. The stencils 109a, 109b are stacked in reverse build order, with the stencil corresponding to the lowest layer stacked at the top, and the stencil for the topmost layer being at the bottom. Each stencil is supported by a corresponding pair of support arms 134. The embodiment shown holds twenty stencils in the lift carousel 133, however, systems for supporting more or fewer stencils are anticipated.

The lift carousel 133 rotates in increments, moving the support arms 134 through a number of pre-determined positions including a top horizontal position where the stencils can be removed from the support arms 134. The lift carousel 133 continues to rotate such that the support arms 134 rise, are flipped over, then lower again until the process is repeated. With respect to the view of FIG. 14, the lift carousel 133 rotates in a clockwise manner indicated by the arrow R.

Once a stencil reaches the top horizontal position, a pneumatic ram 141 or other linear actuator pushes the stencil 109 forward, sliding it off the respective pair of support arms 134. The stencil 109 is pushed onto a top conveyor 143, which rotates in a manner to convey the stencil away from the carousel 133. A plurality of proximity sensors 145 are arranged to detect when the stencil 109b reaches a pre-determined ‘lifting’ position. When the stencil 109 is in this lifting position, a system controller stops the top conveyor 143. From this lifting position, the stencil can be lifted with electromagnetic stencil lifters 35, and positioned in the print assembly 3, as described above.

As the stencil lifters 35 remove the stencil, a signal is sent to a system controller to communicate that the system is in a ‘printing mode’. To store a stencil away, the stencil is placed back in the lifting position by the stencil lifters. The proximity sensors 145 detect that the stencil has been placed on the conveyor, when the stencil 109 is in this position, the system controller starts the top conveyor 143 once again. The used stencil is conveyed to a pair of stencil supports 147 on a second lift from where it is lowered by way of the second lift rotating in a similar manner to the lift carousel 133, thereby lowering the stencil towards the base of the lift 151.

As the stencil 109a approaches the base of the lift 151, it comes into contact and is transferred into contact with a lower carriage 157 carried on a lower conveyor 153. Proximity switch(es) or sensor(s) 155 sense when this transfer onto the lower carriage 157 has occurred and triggers movement of the lower conveyor 153. The lower conveyor 153 then moves the used stencil 109a and carriage 157 towards the base of the lift carousel 133. The stencil is moved from the lower carriage 157 onto a pair of support arms 134 by the lower conveyor 153 for the process to repeat.

In the embodiment shown, the top and lower conveyors are shown as being chains, however other forms of conveyors are envisaged. In some embodiments, the stencil loading apparatus 130 is at least partly enclosed and comprises a heat source to heat the stencil loading apparatus. In an embodiment, the apparatus is heated to around 80 degrees Celsius, thereby preheating the stencils for faster printing. Preferably the conveyor material is suitable for the selected operating temperature of the stencil loading apparatus.

The print assembly including the stencil 9 and stencil lifters 35 is transversely movable horizontally along the frame 5, for example using a pneumatic ram, to position the stencil substantially over the print bed 7 or over one of the print stacks 33a, 33b. When the print assembly 3 is in position, the stencil lifters 35 are operable to release the stencil 9 onto the print table by deactivation of the electromagnet, and to later lift the stencil from the print table 8 by activation of the electromagnet to engage the handles 31.

The print assembly 3 further comprises a mechanism 36 for horizontally moving the stencil 9 to position the stencil relative to the print bed 7 once the stencil lifters 35 have released the stencil 9 onto the print table 8. In the embodiment shown a pneumatic ram 36 is provided.

Each stencil 9 comprises two or more locating notches 27, 27′ or locating protrusions for locating the stencil 9 relative to the print bed 7. In the embodiments shown, the stencil frame 17 and plate 19 each comprise two corresponding notches provided at one end of the stencil plate 19. Locating notches 27, 27′ are cut from the stencil plate 19 during fabrication of the stencil apertures 13, 13′, thereby ensuring accurate positioning of the notches 27, 27′ relative to the apertures 13, 13′ in the stencil plate 19. The notches 27, 27′ have a substantially arcuate shape, for example formed by a semi-circular or semi-elliptical cut-out. However, in alternative embodiment, the notches may comprise one or more straight edges, for example be ‘v’ shaped.

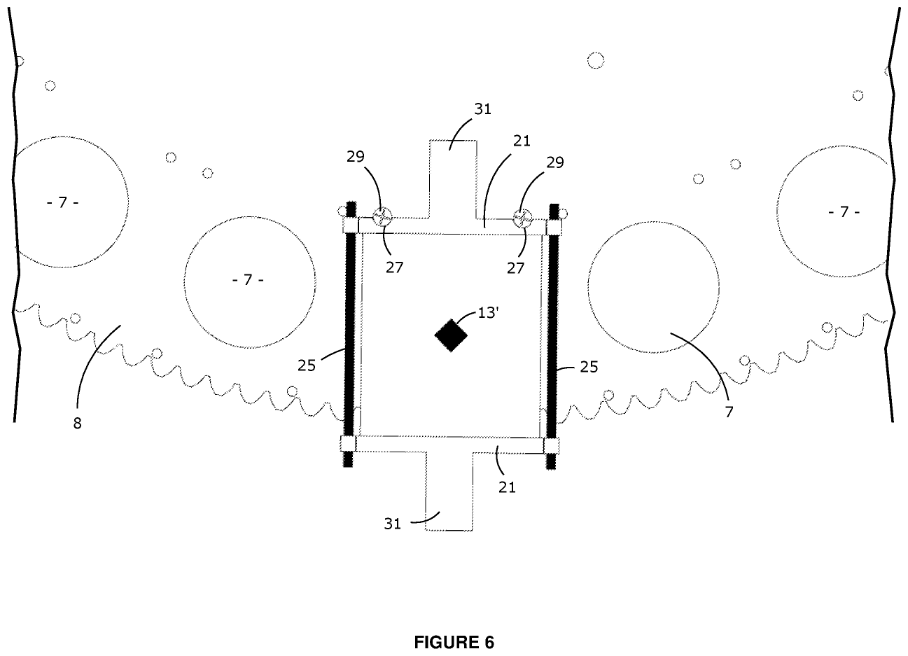

Complementary locating notches or protrusions 29 (FIG. 6) are provided on the print table 8, adjacent to the print bed 7. The notches provided on the frame 17 are generally larger, e.g. with a larger radius, than the notches 27, 27′ on the stencil plate 19. This ensures there is clearance of the frame notches around the edge of the stencil plate notches 27, 27′, thereby ensuring the locating protrusions 29 only contact the notches in the stencil plate. This ensures alignment is relative to the stencil plate 19, not the frame 17.

In the embodiment shown, two locating pins 29 are provided on the print table 8, adjacent to the print bed 7. The pins 29 are spaced apart with a spacing that corresponds to the spacing of the notch centres, and the pins 29 have a shaft with a diameter that corresponds to the radius of curvature of the edge of the notch 27 at or near the middle of the notch. The pins 29 in the embodiment shown are substantially cylindrical but alternatively may be semi-cylindrical, rectangular, or otherwise shaped, with a surface shaped to engage a complementary shaped portion of the edge of the notch.

The horizontal ram 36 is operable to push the stencil 9 towards and into engagement with the pins 29. The pins 29 locate the stencil 9 and substantially prevent any movement of the stencil relative to the print bed 7. The stencil lifters 35 also may be operable to apply a downward force to the stencil 9 to lock the stencil in place.

Any misalignment of the stencil apertures 13 between successive stencils, or movement or deviation in stencil positioning relative to the print bed could result in misaligned printed layers, reducing the accuracy and quality of the printed object. The locating notches and protrusions ensure the stencil apertures of successive stencils are precisely aligned, thereby improving accuracy and repeatability.

Alternative embodiments may comprise alternative alignment means. For example, the stencil 9 may be optically aligned with the print bed 7, for example using fiducials, or may be aligned using sensors. Such methods may advantageously decrease wear on the stencils, but typically would be slower.

A heater 10 is provided to heat the top surface of the stencil 9 that is engaged with the print assembly 3. The heater 10 is configured to heat the stencil to a predetermined temperature that is greater than the melting point of the print material such that the print material will melt or remain in molten when it is placed onto the stencil 9. A sensor may be provided to measure the surface temperature of the stencil, and/or the heater 10 may be configured to heat the stencil 9 for a predetermined amount of time.

The heater 10 may comprise a radiant heater, such as an infrared lamp. In the present embodiment, two elongate infrared lamps 12a, 12b are positioned adjacent the sides of the stencil 9. The number of heaters/lamps and the power rating of each heater/lamp will depend on the size of the stencils to be heated, and the required heating time. In some embodiments additionally or alternatively, the stencil stacks 33a, 33b may be provided with a heater to pre-heat the stencils. For example, the stencil stacks may be positioned within an oven. In some embodiments, each stencil may be pre-loaded with wax in the oven such that the stencil and wax are ready for printing immediately after each stencil change.

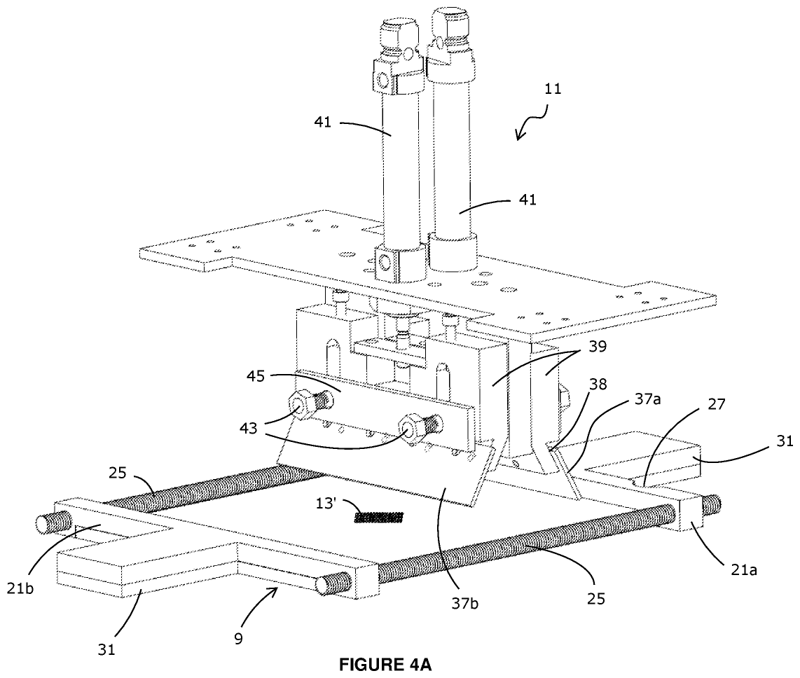

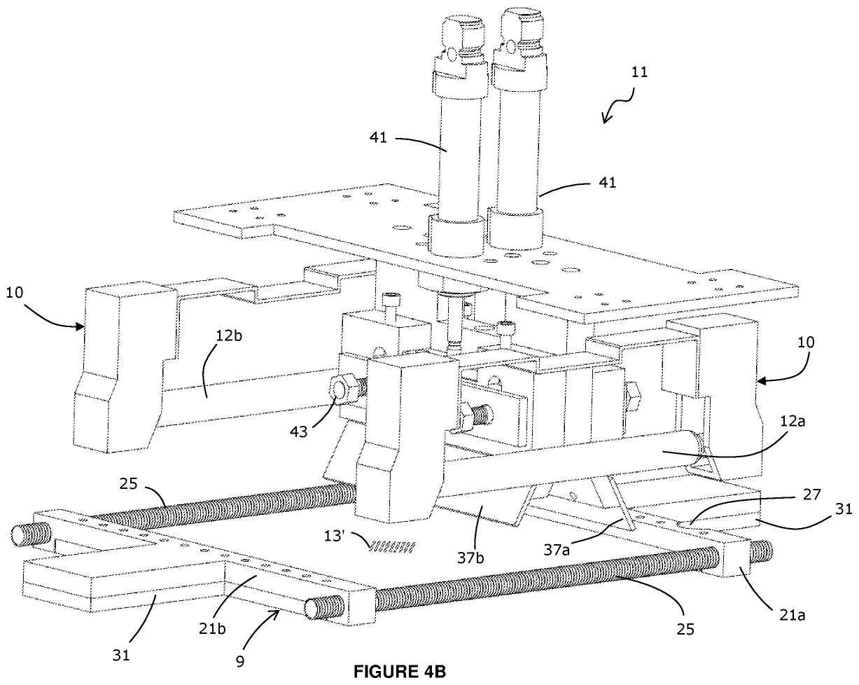

FIGS. 4A and 4B show a squeegee assembly 11 for spreading the print material across the stencil 9. The squeegee assembly 11 comprises a pair of angled squeegee blades 37a, 37b, although alternative embodiments may comprise only a single blade.

Each squeegee blade 37a, 37b is attached to a holder 39 that can move up and down independently using a pneumatic ram 41. The squeegee blades 37a, 37b are angled relative to the top surface of the stencil plate. In embodiments having two squeegee blades 37a, 37b, one blade 37a is configured for use in a first direction, and the other blade 37b is oppositely angled, configured for use in a second, opposite direction.

The leading surface of each squeegee blade forms an acute angle θ with the top surface of the stencil 9. In the embodiment shown, the squeegee blades are both angled at substantially the same angle θ, with the leading surfaces generally facing each other. However, in alternative embodiments the leading surfaces may face generally away from each other.

In the embodiment shown, each blade holder 39 has an angled surface 38 against which the respective blade 37a, 37b rests. The squeegee blade 37a/37b is attached to the respective angled surface 38 at or adjacent a top edge of the squeegee blade. A washer plate 45 is movably attached to each blade holder 39 via two spring loaded pins 43. A lower edge of each washer plate 45 contacts a respective squeegee blade 37a, 37b. Two spring-loaded pins 43 urge the washer plate 45 towards the blade holder 39 thereby applying downward pressure to the respective squeegee blade 37a/37b and to resist rotation of the blade 37a/37b about its top edge and relative to the holder 39. The washer plate 45 evenly distributes the force from the spring loaded pins 43 to the squeegee blade 37a/37b as a downwards force to help distribute the downwards pressure evenly across the stencil.

As the squeegee blade is moved across the stencil plate, the spring loaded pins 43 and washer plate 45 urge the squeegee blade 37a, 37b into contact with the stencil plate 19 and provide sufficient downwards pressure to ensure the respective squeegee blade 37a, 37b remains in contact with the top surface of the stencil plate throughout the movement, thereby achieving substantially uniform distribution of the melted print material. Nuts may be provided on the spring loaded pins to allow for adjustment of the spring force applied to the stencil.

The squeegee blades 37a, 37b are resilient and able to flex upon contact with the stencil. That is, they should be flexible enough to avoid damage to the stencil plate upon contact, resilient to recover from any flexing, but sufficiently stiff to wipe the printing material across the stencil plate at the operating temperature.

The blades 37a, 37b comprise a material that exhibits a low coefficient of friction with the surface of the stencil plate (typically stainless steel) and at the operating temperature of the stencil. The blades 37a, 37b also preferably comprise a material and a surface finish that demonstrates low adhesion to the printing material for ease of cleaning. In the embodiment shown, the blades 37a, 37b comprise polytetrafluoroethylene (PTFE/Teflon). PTFE advantageously has a low coefficient of friction with stainless steel, good wear resistance, results in low wear to a stainless steel stencil, and is heat resistant up to 200° C. In alternative embodiments, the blades 37a, 37b may comprise an alternative polymer, or metal, for example, stainless steel, copper, or aluminium.

The print assembly 3 further comprises a material applicator (not shown) to place printing material onto the stencil 9 once the stencil is engaged with the print assembly or before the stencil is engaged with the print assembly. The print material is placed to one end of the stencil apertures 13, between the stencil apertures 13 and a respective end support 21, adjacent the beginning position for the squeegee.

In some embodiments additionally or alternatively, the material applicator may comprise an applicator heater to pre-heat or melt the printing material before dispensing it onto the stencil.

FIG. 1 illustrates a method of using the above described apparatus 1 to manufacture an object. The printing procedure begins by picking up a first stencil 119 using the stencil lifters 35. The electromagnets and pneumatic cylinders in the lifters 35 engage and lift the stencil 119 from the stencil stack 133.

The stencil 9 is then heated to a temperature sufficient to melt the printing material, keep pre-molten material molten, or for a viscous printing material, to reduce the viscosity of the printing material to a desired level for spreading. The stencil 9 may have been pre-heated prior to lifting.

In the present embodiment, the printing material 102 comprises wax, and the stencil 119 is heated to a temperature of between about 81° C. and 87° C. Temperature control to within this range helps minimise the likelihood of print defects due to the print material being too hot and melting the underlying layer, or being too cool to print fully and to bond to the underlying layer.

The length of time to heat the stencil 9 is a function of the power rating of the heater 10, the initial temperature of the stencil, the size of the stencil, and the relative thermal properties of the stencil plate 19 and frame 17. The stencil plate 19 may reach the desired temperature faster than the frame 17. It is desirable that both the stencil plate 19 and the stencil frame 17 reach substantially the same temperature before printing to avoid a reduction in the tension in the plate 19 due to a higher level of expansion of the stencil plate 19 compared to the frame 17. This may be achieved by using materials for the stencil plate 19 and frame 17 with similar material properties.

The printing assembly 3 is moved transversely along the frame 5, to position the stencil generally over the print bed 7. The pneumatic cylinders in the lifters 35 lower the heated stencil 119 into contact with the print table 8, the electromagnets are then disengaged to release the stencil 9. The horizontal ram 36 then pushes the stencil 9 by pushing against one of the stencil handles 31, into the printing position in which the notches 27 on the stencil frame 17 engage the locating pins 29 on the print table 8. The lifters 35 then lower further to press and lock the stencil 119 into contact with the print table 8.

At this stage or prior to positioning the stencil 9, the print bed 7 is raised (or lowered) into a printing position below the top surface of the print table 8, in which that the distance between the under surface of the stencil plate 19 and the print surface is the sufficient to accommodate any anticipated deflection of the stencil plate 19 due to the force applied by the squeegee 11, without the stencil plate 19 contacting the print surface (for printing of the first layer) or the upper surface of the partly printed object (for subsequent layers).

A quantity of printing material is dispensed onto the heated stencil between the stencil apertures 13 and a first one of the end supports 21. The printing material may be in solid form, for example, as pellets, and allowed to melt. Alternatively, the printing material may be pre-melted or pre-heated and injected or otherwise dispensed onto the heated stencil.

A first one of the two squeegee blades 37a is positioned and lowered into contact with the stencil plate 19 adjacent a first end of the stencil plate, with the trailing surface of the blade 37a facing and adjacent the respective frame end member 21a (as shown in FIG. 4A) such that the printing material is on the leading side of the squeegee blade.

The squeegee assembly 11 and thereby the first blade 37a is moved horizontally towards the opposite second end of the stencil. This movement may be achieved using any suitable mechanism for linear motion, the present embodiment comprises two stepper motors and slide rails, for example linear ball bearing rails.

As the squeegee blade 37a is moved across the stencil plate 19, it forces molten printing material through the stencil apertures 13 onto the print surface to form a first layer 104 of the object. As the molten material contacts the cooler print surface it hardens.

In the process of printing a layer, the squeegee 11 pushes down on the stencil plate 19 causing some deflection of the plate. If the stencil deflects too much, an excessive volume of material may be printed resulting in unwanted ‘bridging’ of features where two printed features become connected with unwanted material.

To avoid this unwanted deflection, it is desirable to ensure the pre-tensioning of the stencil plate is sufficient to limit such deflection to within an acceptable range for the print material and the print resolution. The tension in the stencil plate may be tuned, for example using two threaded shafts frame side members 24. In the present embodiment, the deflection of the centre stencil under a 200 g (2 N) pin mass was set to 200 microns. However, in other embodiments with alternative print materials, or with different aperture sizes or print layer thicknesses, other deflections may be suitable. It will be apparent to a person skilled in the art that an allowable deflection can be determined through a simple process of trial and error, checking for print defects for differing tension levels.

Once the squeegee blade 37 is adjacent to the second end of the stencil, the printing of the layer is complete. While the squeegee is still in contact with a top surface of the stencil plate, the print bed 7 is lowered, moving it away from the stencil to increase a vertical spacing between the stencil 9 and the print bed 7. The print bed is lowered at least the depth of a print layer, but more preferably is lowered by a distance of two or more times the depth of the print layer.

After the print bed 7 has been lowered, the squeegee blade 37 is lifted out of contact with the stencil. Lowering the print bed 7 before lifting the stencil enables control over the speed of separation between the stencil and the printed layer, since the stencil will raise slightly after the downward force from the squeegee is released.

To unlock the stencil 9 from position on the print table 8, the lifters 35 lift off the stencil with the electromagnets are disabled. The horizontal ram 36, engaged with the stencil using an activated electromagnet, pulls the stencil 9 out of engagement with the notches 27. This movement of the stencil is about or slightly more than the depth of the notches, for example about 5 mm. The stencil 119 is then lifted from the print table using the stencil lifters 35. The electromagnets and pneumatic cylinders in the lifters 35 engage and lift the stencil 119.

The printing assembly 3 is moved transversely back along the frame 5, to position the stencil 9 generally over the second stencil stack 33b. The pneumatic cylinders in the lifters 35 lower the heated stencil 119 onto the second print stack 33b, and the electromagnets are then disengaged to release the stencil.

Due to surface roughness of the stencil surface, some printing material may remain in contact with the under surface of the stencil plate after printing of a layer. If this excess material is not removed it may reduce the print accuracy of subsequent layers printed using that stencil, particularly for very small objects. Before the stencil is placed in the second print stack 33b, any residual print material may be cleaned from the stencil, for example by wiping the underside or both the top and bottom surfaces of the stencil 9 with a roller, wiper and/or an absorbent material such as a tissue.

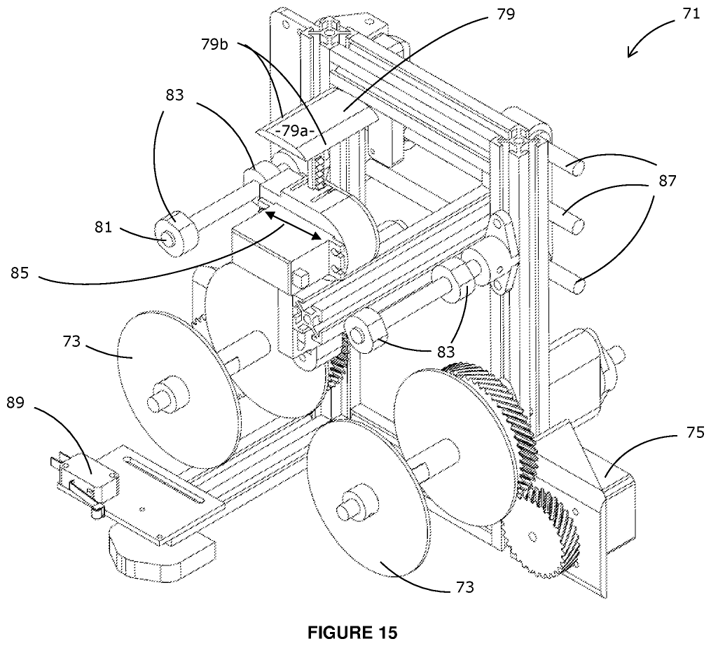

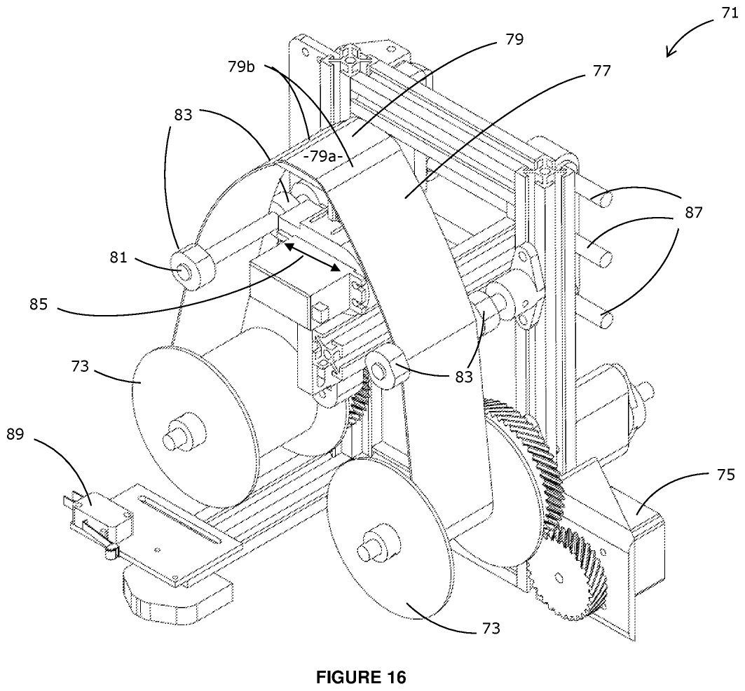

FIGS. 15 and 16 show one embodiment of a stencil cleaner apparatus 71 for cleaning wax and other debris from a used stencil or stencils. The stencil cleaner 71 comprises two ribbon spools 73, each with an associated motor 75 for selectively driving the spool 73. As shown in FIG. 16, ribbon 77 extends from a first one of the spools 73, over a cleaning head 79, and to the second spool 73. Guide rods 81 are positioned between the spools 73 and the cleaning head 79 to assist with correctly positioning and tensioning the ribbon 77. The guide rods 81 comprise end stops 83 to prevent lateral movement of the ribbon off the cleaning head 79. The first one of the spools 73 is loaded with a spool of cleaned and dried ribbon 77, which is passed over the cleaning head 79 and to the second one of the spools 73. The second spool motor operates to pull the ribbon from the first spool and wind it onto the second spool. While this occurs, the first spool motor is electrically disabled to allow the first spool to rotate freely. The process can be selectively reversed, with the first spool motor operating to pull the ribbon from the second spool and wind it onto the first spool.

The cleaning head 79 comprises a substantially flat top surface 79a for contacting the underside of the stencil. The edges 79b of the cleaning head are preferably curved to enable the ribbon 77 to smoothly glide over the cleaning head and to minimise wear to the ribbon 77. The cleaning head 79 is mounted on a movable cassette 85. The cleaning head 79 moves up and down on the moveable cassette 85 such that it can be moved into and out of contact with the underside of a stencil. The cassette 85 in turn is mounted to move forward and backwards via guide rods 87. The cassette 85 positions the cleaning head, and the ribbon positioned on the cleaning head, underneath a used stencil.

To clean a stencil, the stencil cleaner apparatus 71 is positioned under a used stencil by way of the moveable cassette 85. The cleaning head 79, and thereby the ribbon 77 extending over the cleaning head 79, is moved up into contact with the stencil. The spool 73 for collecting the used ribbon is turned in a direction to pull clean ribbon from the other spool 73 and wind it onto the used ribbon spool, while the ribbon is in contact with the stencil, thereby pulling the ribbon over the surface of the stencil. As the ribbon 77 is pulled over the cleaning head 79, the cleaning head is also moved back and forward to wipe the unwanted or excess wax or other debris from the stencil. The ribbon 77 acts to absorbs the unwanted or excess wax or other debris.

The ribbon 77 typically comprises a woven textile, for example satin. Preferably the ribbon material is a smooth, low-lint fabric, which is able to absorb unwanted or excess wax or other debris. After the ribbon from the first spool has been used, the spools are replaced. The used ribbon fabric may be disposed of or it may be cleaned, dried, and reused in the process, by being loaded on to another spool. The stencil cleaner apparatus 71 is preferably arranged adjacent or forms part of the stencil loading apparatus discussed above, and is configured to clean unwanted or excess wax or other debris from the stencils before they are returned to the lift carousel. In the embodiment shown, the stencil cleaner apparatus 71 is for use with a rotary print table. Each print station of the rotary print table comprises one or more tabs or other features to identify a point on the print table. A switch 89 is provided on the stencil cleaner apparatus 71. This switch 89 is activated upon contact with one or more tabs or other features on the print station, to detect when the stencil cleaner apparatus 71 is correctly aligned with the print station and to thereby communicate when the stencil cleaner should be activated.

The above mentioned process as described in relation to FIG. 1 is then repeated, as indicated by loop 120 in FIG. 1, with a second stencil, then subsequent stencils, building up an object 106 in a layer wise manner.

During printing with the second stencil, the second squeegee blade 37b is used. The second squeegee blade 37b is positioned and lowered into contact with the stencil adjacent the second end of the stencil plate 19, with the trailing surface of the blade 37b facing and adjacent the respective frame end member 21b (as shown in FIG. 4A). A quantity of printing material is dispensed onto the heated stencil this time between the stencil apertures 13 and a second one of the end supports 21, such that the printing material is adjacent the squeegee blade on the leading side of the blade. The squeegee assembly 11 and thereby the second blade 37b is moved horizontally towards the first end of the stencil in the same but opposite manner as described above.

The apparatus shown in FIG. 2 comprises a single print assembly or print station 3, and a plurality of print beds 7 arranged around the periphery of a rotatable print table 8. Rather than printing a single object using the method described above, this arrangement enables a plurality of objects to be printed simultaneously. Once a layer has been completed on a first one of the print beds 7, the print bed lowered and the stencil lifted, the print table 8 is rotated to position a second one of the print beds 7 under the stencil 9. An underside of the stencil may be cleaned. The same stencil is then lowered into position on the print table 8 over the second print bed and the second print bed raised. The process of printing the layer is repeated for multiple print beds 7 without changing the stencil. Once a given layer has been printed on to each of the print beds, the stencil is changed following the process described above.

The dual squeegee blade arrangement is particularly advantageous in such a system where the same stencil is used multiple times consecutively, as it enables the print material to be wiped in either forward or backward directions, without having to move the squeegee back after printing each layer, hastening printing time. It also allows excess print material wiped from one direction to be wiped back for printing the next layer eliminating the need to clean the excess wax from the top surface after printing in one direction. In contrast, some embodiments may comprise only a single squeegee blade, but these embodiments require the squeegee to be moved back to the starting position. Alternatively, to achieve a similar capability, the apparatus may comprise a single squeegee blade with an adjustable tilt such that the angle of the blade can be changed for each print pass.

In alternative embodiments, a plurality of print stations may be provided, with each print station having only a single stencil and corresponding to a layer of the object. The print stations are arranged in print order and a given print bed is moved under a first one of the print stations for printing a first layer, then under a second print station for printing a second layer, and continuing to move to subsequent print stations for the printing of subsequent layers. In such an embodiment, the print beds 7 may be provided on a rotary table such as the one shown in FIG. 1, with the number of print beds being equal to or greater than the number of unique layers in the printed object 106. Alternatively, the print beds may be otherwise provided and moved laterally between stations. For example, the print bed may be provided on a belt or as part of a chain-like production line, and moved between stations. For long chain systems, to reduce inertial forces on the print beds and the printed object from intermittently stopping movement of the table or chain when the print beds are moved between stations, the print stations may be configured to travel with the table or chain while printing.

In alternative embodiments having a plurality of print stations, each print station may comprise a plurality of interchangeable stencils such that each print station prints multiple unique layers of the object. This arrangement still necessitates stencil changes but will reduce the number of changes required by a factor corresponding to the number of print stations.

Optionally the system or apparatus may comprise one or more other stations in addition to the print station 3. For example it may comprise secondary material application station, a curing or heating station, a vacuum application station, a station for shaving the top surface of a layer of the object, or an object removal station.

The above described printing method is envisaged for use to print moulds or supports, in particular wax moulds, for manufacturing an article. In these embodiments, the material for the final article is not applied via the stencils, but is applied to the printed or partly printed mould by a secondary material applicator. The secondary applicator may be configured to apply a powdered solid material such as a metal powder to the printed or partly printed mould, during printing or after the mould is taken off the machine.

The method illustrated in FIG. 1 is a method of manufacturing a hydrogel object 116. In this embodiment, the object 106 produced by the layer-wise manufacturing process described above is a wax mould that is then used for forming the hydrogel object. The second printing material comprises a cellulose solution 109 to form the hydrogel.

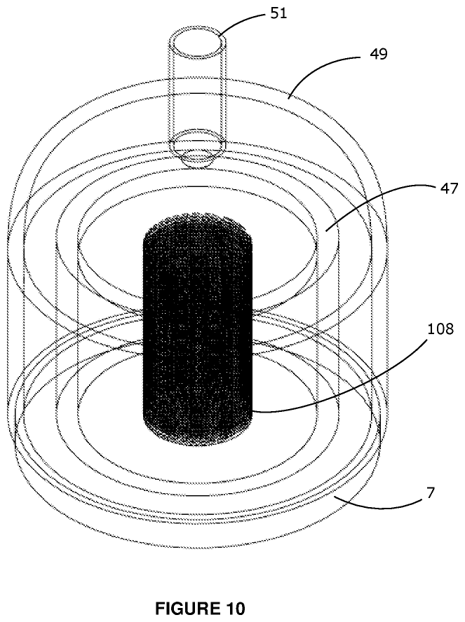

Once the wax mould 106 has been printed, the mould is submersed in the cellulose solution 109, or the mould 106 is injected 108 with the liquid 109. Prior to the injection of the cellulose solution to the mould or the submersion of the mould, a cylindrical tube 47 is placed on the print bed 7 as shown in FIG. 10, to contain the solution and to support and shape a cylindrical cellulose gel column.

In the present embodiment, the cylindrical tube 47 comprises a polycarbonate tube that is sealed to the print bed to prevent the cellulose solution from leaking under the bottom of the tube 47. For example, the tube may comprise a thread at one end to enable it to be screwed onto a complementary thread on the print bed 7, and a sealing gasket (not shown) was placed around the join between the tube and the platform to create an airtight seal.

In a next step, 110, a cover 49 is placed over the tube and the cellulose containing object (see FIG. 10). A vacuum is applied to the object via an inlet 51 in the cover 49, to create a negative pressure within the cover, to remove any air bubbles trapped within the mould. The cover is sealed to the tube or to the print bed around the tube.

Once any air has been removed, the object is removed from the print bed and tube. In some embodiments, this removal step may be automated, for example using a robotic arm to remove the polycarbonate tubes and to remove the object from the apparatus.

The removed object is then placed in a preheated oven 112 to gel the cellulose solution, thereby forming a gel. For the exemplary cellulose embodiment, the oven temperature is preferably at least 50° C. Gelling time varies depending on the oven temperature and the size of the column.

In alternative embodiments, rather than a cellulose solution, the second material may comprise any alternative gel-able polymer, for example, agarose, gelatin, hyaluronic acid or collagen.

Once the cellulose is set, the wax mould is removed. To do this, the object is heated to a temperature higher than the melting point of the wax (50° C.-70° C.), but not high enough to damage or melt the gel structure. This is preferably achieved by submerging the mould in a hot water bath 114, for example water having a temperature of around 90° C.

Due to the immiscible nature of the water and molten wax, the cellulose gel quickly separates from the wax mould as it melts. The molten wax floats on the water bath and can be collected for recycling. This advantageously minimises waste by-products from the manufacturing process, improving sustainability and reducing cost.

After the majority of the molten wax has been collected, a surfactant such as a soap is added to the water bath to wash the cellulose gel and remove any wax residues left. The hydrogel object is then removed from the bath, and any excess material may be trimmed from the object.

In alternative embodiments, variations of the above methods may be used to manufacture metal or polymer objects.

In an embodiment for manufacturing a metal component, a mould such as a wax mould is manufactured according to the above methods. Every layer, or periodically every few layers, powdered metal is applied to the partly formed mould, filling the cavities in the mould. Alternatively, the mould may be printed in its entirety before placing powdered metal into the mould cavities. To ensure a tight packing of the mould with the metal powder, a vibration may be applied to the object, for example, via the print bed 7. The apparatus may further comprise a tertiary material applicator such as an ink jet type applicator to apply a binder to the powdered metal. The binder is then cured according to the requirements of the binder used, for example using UV light, before printing the next mould layer. Therefore, in this embodiment, a green body for the metal object is formed in tandem with the mould.

The green body is then sintered to bond the metal particles and form the final object. The sintering may be by any appropriate means, for example utilising a heat exchanger such as a thin wall heat exchanger, or a catalytic converter, and/or the sintering may be carried out in a vacuum or inert gas oven. This sintering will cause the wax mould to melt, leaving the sintered metal component. Alternatively, depending on the properties of the green body, the wax mould may be removed prior to sintering by first placing the green body-wax component in a water bath, as described above.

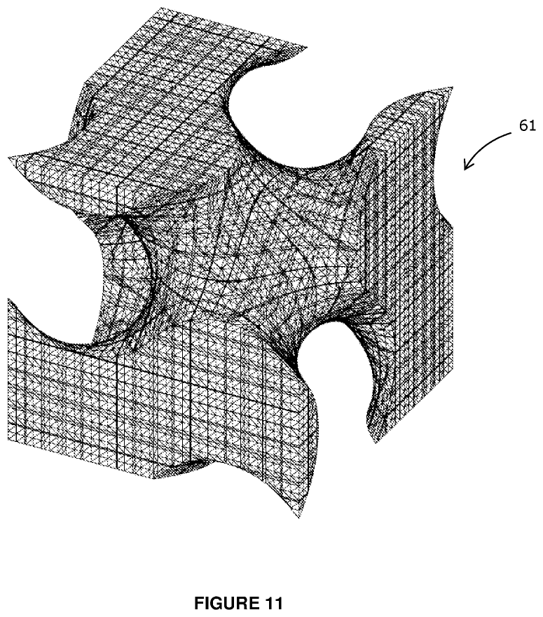

FIGS. 11 to 13 illustrate the geometry of one example embodiment hydrogel object for chromatography applications that can be manufactured using the above described methods. The object 116 is a gyroid-based hydrogel column comprising a three dimensional network of gyroid units.

A network gyroid unit 61 is shown in FIG. 11, modelled as a common Triply Periodic Minimal Surface (TPMS). The TPMS model was generated using the equation below to approximate the surface, giving a non-minimal surface close to the true gyroid.

sin(x)×cos(y)+sin(y)×cos(z)+sin(z)×cos(x)=0

The fundamental patch is composed of eight isometric skew hexagons, six of which have a vertex at the centre of the patch. By default, the channel size generated in the model was Pi in diameter.

Using solid modelling software, a two-dimensional 15×15 array 63 of the gyroid units 61 was modelled. This network model was then sliced horizontally into a plurality of layers using the modelling software. The number of the slices being dependent on the manufactured part size and on the desired resolution. In this example, the 50% porous gyroid cell unit with 0.5 mm channel size and 1 mm sides, was sliced into 20 layers of 0.05 mm in thickness. However, it will be apparent the unit cells can be scaled to any desired dimension.

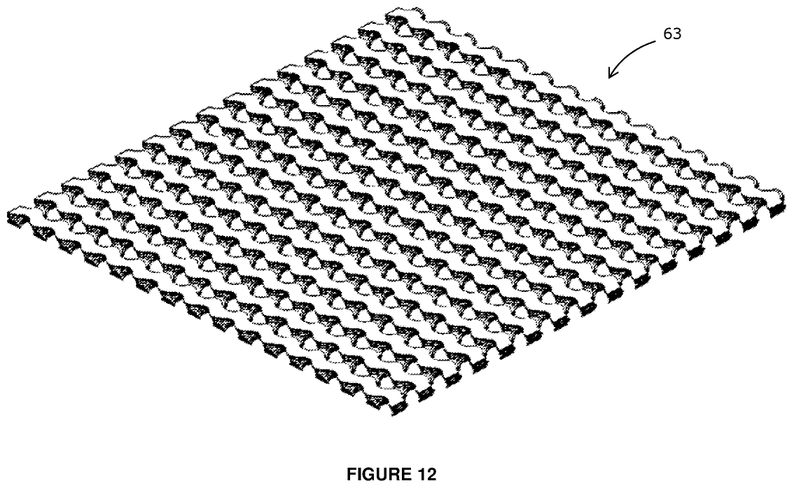

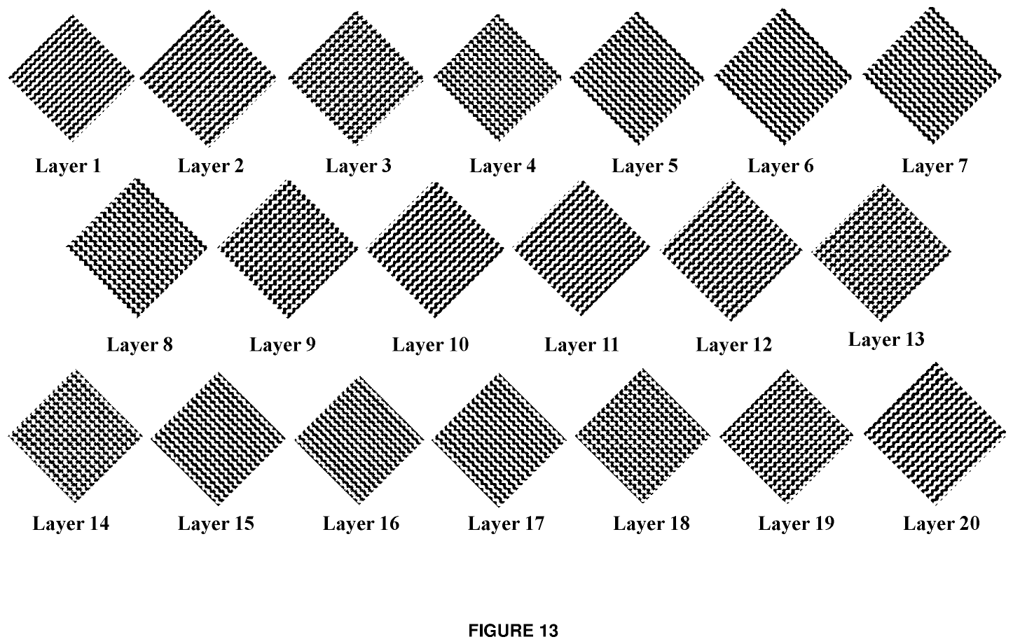

Each of these layers is illustrated in FIG. 13. The layers were each used to fabricate a corresponding stencil and print a layer of a gyroid array using the method described above. The successive printing of the first layer to the last layer with the stencils resulted in the creation of the two dimensional gyroid array of FIG. 12. Repeating this process multiple times with the 20 stencils creates a three dimensional column comprising multiple stacked and connected two-dimensional arrays 63 and interconnected TPMS channels.

For manufacturing a complete wax mould gyroid column with 500 micrometre channel size, and a width of 50 mm with the apparatus of FIG. 2, each wax layer took about 4 seconds to print. In an example embodiment having 24 print stations 3 around the print table 8, one complete revolution takes 120 seconds (allowing 1 second for movement of the print beds between subsequent print stations 3) and results in the printing one layer for each 24 parts. Thermal 3D screen printing of 24 parts 50 mm in height and 0.05 mm layer thickness is estimated to take about 2000 minutes (33.3 hours) or about 83 minute (1 hour 23 minutes) for a single part. In contrast, the commercially available Solidscape 3D printer takes between 28-32 hours to print a single part having the same dimensions and requires a further 5-7 days to remove the support material. Therefore, the embodiments of the present invention advantageously offer a faster method for manufacturing such components, and a method that is suitable for the mass production of components.

Preferred embodiments of the invention have been described by way of example only and modifications may be made thereto without departing from the scope of the invention. For example, rather than using the above described screen printing method for the manufacture of a wax mould, the wax mould may be manufactured using alternative techniques such as using an inkjet type printer, or fused deposition modelling, then used to manufacture a hydrogel object according to the steps described above.

Although the method has been exemplified for the manufacture of a wax mould and a hydrogel gyroid-based column structure, it will be appreciated that the method and apparatus described above is intended for the manufacture of a broad range of other structure shapes and is not limited to wax moulds or gel-based structures.

1. An apparatus for the manufacture of an object, comprising:
a print bed;
a stencil having one or more apertures, the stencil being positionable over the print bed;
a heater arranged to heat the stencil; and
a squeegee movable to spread a printing material across the stencil and to thereby force printing material through the stencil aperture(s);
wherein one or both of the stencil and the print bed is movable to adjust the spacing between the stencil and the print bed.

2. An apparatus as claimed in claim 1, wherein the print bed is vertically movable to raise and lower the print bed relative to the stencil.

3. An apparatus as claimed in claim 1 or 2, wherein the heater comprises a radiant heater.

4. An apparatus as claimed in claim 3, wherein the heater comprises one or more infrared lamps.

5. An apparatus as claimed in any preceding claim, wherein the stencil comprises a frame and a stencil plate that is pre-tensioned by the frame; and wherein the stencil aperture(s) is/are provided in the stencil plate.

6. An apparatus as claimed in claim 5, wherein the frame comprises first and second end supports attached to the plate, and elongate first and second side members extending between the end supports; and wherein the side members apply a pre-tension to the stencil plate via the end supports.

7. An apparatus as claimed in claim 6, wherein the side members comprise threaded rods, each rod being provided with one or more nuts that is adjustable to adjust the pre-tension applied to the stencil plate.

8. An apparatus as claimed in any one of claims 5 to 7, wherein each side member comprises a biasing member acting between said side member and an end support to apply the pre-tension.

9. An apparatus as claimed in any one of claims 5 to 8, wherein the stencil plate comprises stainless steel.

10. An apparatus as claimed in any preceding claim, wherein the heater is configured to heat the stencil to a predetermined temperature sufficient to melt and/or keep molten the printing material when the printing material is in contact with the stencil.

11. An apparatus as claimed in claim 10, wherein the predetermined temperature is a temperature of between about 81° C. and 87° C.

12. An apparatus as claimed in any preceding claim, wherein the stencil comprises two or more locating notches or locating protrusions for locating the stencil relative to the print bed.

13. An apparatus as claimed in claim 12, further comprising a print table, the print beds being mounted to the print table; and wherein the print table comprises two or more locating notches or locating protrusions complementing the locating notches or locating protrusions of the stencil, to locate the stencil relative to the print bed.

14. An apparatus as claimed in claim 12 or 13, wherein the stencil comprises two locating notches, the notches being substantially arcuate.

15. An apparatus as claimed in any preceding claim, wherein the squeegee comprises an angled blade, and wherein a leading surface of the blade forms an acute angle with a top surface of the stencil.

16. An apparatus as claimed in claim 15, wherein the squeegee comprises a pair of oppositely angled blades.

17. An apparatus as claimed in claim 15 or 16, wherein the blade(s) comprise(s) polytetrafluoroethene.

18. An apparatus as claimed in claim 16, wherein each squeegee blade is independently movable towards and away from the top surface of the stencil.

19. An apparatus as claimed in any preceding claim, further comprising a secondary material applicator configured to apply a second printing material to objects formed or partly formed by the first printing material.

20. An apparatus as claimed in any preceding claim, further comprising a cleaner configured to remove printing material from an underside of the stencil.

21. A system for the manufacture of an object, the system comprising:
a print station comprising:
a stencil having one or more apertures;
a heater arranged to heat the stencil; and
a squeegee movable to spread a printing material across the stencil and thereby force printing material through the stencil aperture(s); and
a print bed that is laterally movable relative to the print station.

22. A system as claimed in claim 21, wherein one or both of the stencil and the print bed is movable to adjust a vertical spacing between the stencil and the print bed.

23. A system as claimed in claim 21 or 22, comprising a movable print table, the print table comprising a plurality of print beds.

24. A system as claimed in claimed in claim 23, wherein the print table is rotatable to laterally move the print beds relative to the print stations.

25. A system as claimed in claim 23 or 24, wherein the stencil comprises two or more locating notches or locating protrusions, and wherein the print table comprises two or more locating notches or locating protrusions complementing the locating notches or locating protrusions of the stencil, at each print bed, for locating the stencil relative to the respective print bed.

26. A system as claimed in claim 25, wherein the stencil comprises two locating notches having a fixed position relative to the one or more apertures.

27. A system as claimed in claim 26, wherein the notches comprise a substantially arcuate edge.

28. A system as claimed in any one of claims 21 to 27, wherein the heater comprises a radiant heater.

29. A system as claimed in any one of claims claim 21 to 28, wherein the stencil comprises a frame and a stencil plate that is pre-tensioned by the frame; and wherein the stencil aperture(s) is/are provided in the stencil plate.

30. A system as claimed in claim 29, wherein the frame comprises first and second end supports attached to the plate, and elongate first and second side members extending between the end supports; and wherein the side members apply a pre-tension to the stencil plate via the end supports.

31. A system as claimed in any one of claims 21 to 30, wherein the heater is configured to heat the stencil to a predetermined temperature sufficient to melt the printing material when the printing material is in contact with the stencil.

32. A system as claimed in claim 31, wherein the predetermined temperature is a temperature of between about 81° C. and 87° C.

33. A system as claimed in any one of claims 21 to 32, wherein the squeegee comprises an angled blade, and wherein a leading surface of the blade forms an acute angle with a top surface of the stencil.

34. A system as claimed in claim 33, wherein the blade comprises polytetrafluoroethylene.

35. A system as claimed in any one of claims 21 to 34, further comprising one or more of: a secondary material application station, a curing or heating station, a vacuum application station, and an object removal station.

36. A system as claimed in claim 35, comprising a secondary material application station having a secondary material applicator configured to apply a second printing material to objects formed or partly formed by the first printing material.

37. A system as claimed in any one of claims 21 to 36, further comprising a cleaner configured to remove printing material from an underside of the stencil.

38. A system as claimed in any one of claims 21 to 37, comprising a plurality of printing stations.

39. A method of manufacturing an object comprising the steps of:
providing a print bed;
providing a stencil having one or more apertures, and positioning the stencil over the print bed;
heating the stencil;
applying a printing material to the stencil;
moving a squeegee across the stencil to force molten printing material through the stencil aperture(s) to form a printed layer; and
moving one or both of the stencil and the print bed to adjust a vertical spacing between the stencil and the print bed.

40. A method as claimed in claim 39, wherein stencil comprises two or more locating notches or locating protrusions, and wherein the step of positioning the stencil over the print bed comprises engaging the notches or protrusions with complementary notches or protrusions on or adjacent the print bed.

41. A method as claimed in claim 39 or 40, wherein the stencil comprises a stencil plate and a frame, and comprising the step of applying a tensile force to the stencil plate via the frame.

42. A method as claimed in any one of claims 39 to 41, wherein the step of heating the stencil comprises heating the stencil to a predetermined temperature sufficient to melt the printing material when the printing material is in contact with the stencil.

43. A method as claimed in claim 42, wherein the printing material comprises wax, and the predetermined temperature is a temperature of between about 81° C. and 87° C.

44. A method as claimed in any one of claims 39 to 43, wherein the step of moving one or both of the stencil and the print bed to adjust a vertical spacing between the stencil and the print bed comprises, after moving the squeegee across the stencil to force molten printing material through the stencil aperture(s) and while the squeegee is in contact with a top surface of the stencil, moving the print bed away from the stencil to increase a vertical spacing between the stencil and the print bed.

45. A method as claimed in any one of claims 39 to 44, further comprising the step of removing the stencil from over the print bed, and placing a second stencil over the print bed, and after placing the second stencil over the print bed, moving the print bed towards the stencil to decrease a vertical spacing between the stencil and the print bed.

46. A method as claimed in any one of claims 39 to 45, further comprising the step of moving the print bed laterally any one of: a secondary print station, a secondary material application station, a curing or heating station, a vacuum application station, or an object removal station.

47. A method as claimed in any one of claims 39 to 46, further comprising the step of applying a second printing material to the printed layer or layers of the first printing material.

48. A method as claimed in any one of claims 39 to 47, further comprising a cleaning step comprising removing printing material from an underside of the stencil.

49. A method as claimed in any one of claims 39 to 48, wherein the squeegee comprises an angled blade, and wherein a leading surface of the blade forms an acute angle with a top surface of the stencil.

50. A system as claimed in claim 32, wherein the blade comprises polytetrafluoroethylene.

51. A method as claimed in any one of claims 39 to 50, wherein the printed layers of the printing material form a mould, and further comprising the steps of:
submersing the mould in a liquid or injecting the mould with a liquid; and
curing or setting the liquid.

52. A method as claimed in claim 51, wherein the liquid comprises cellulose.

53. A method as claimed in claim 51 or 52, comprising applying a vacuum to the liquid containing mould before curing or setting the liquid.

54. A method as claimed in any one of claims 51 to 53, comprising the step of heating the mould to melt the mould material.

55. A method as claimed in claim 54, wherein the step of melting comprises submerging the mould in hot water.

56. An object when manufactured according to the method as claimed in any one of claims 39 to 50, wherein the object is a mould.

57. An object as claimed in claim 56, wherein the mould is a wax mould.

58. An object as claimed in claim 56 or 57, wherein the mould comprises a biocompatible material.

59. An object when manufactured according to the method claimed in any one of claims 51 to 55, wherein the object is a gel object.

60. An object as claimed in claim 59, wherein the object comprises a gel column.

61. An object as claimed in claim 59 or 60, wherein the object comprises a plurality of gyroid structures.

62. An object when manufactured according to the method claimed in any one of claims 39 to 55, wherein the object comprises a metal or polymer.
